(19) United States
(12) Patent Application Publication
(10) Pub. No.: US 2013/0048670 A1
(43) Pub. Date: Feb. 28, 2013

(54) SEALED GLASS CONTAINER WITH A DISPLACEABLE PLUNGER

(71) Applicant: Andy Greter, Baar (CH)

(72) Inventor: Andy Greter, Baar (CH)

(73) Assignee: MEDMIX SYSTEMS AG, Rotkreuz (CH)

(21) Appl. No.: 13/696,104

(22) PCT Filed: Apr. 18, 2011
(86) PCT No.: PCT/CH2011/000085

§ 371 Date: Nov. 5, 2012

(30) Foreign Application Priority Data
May 17, 2010 (CH) 764/10

(51) Int. Cl. B67D 7/60; B23P 17/04

(52) U.S. Cl. 222/82; 222/386; 29/428; 222/137

(57) ABSTRACT

A container (100) for storing a sensitive or aggressive product is disclosed. The container comprises a hollow basic body (110) made of natural glass. A plunger (120) is arranged displaceably in the interior of the basic body. In order to seal the container so as to be diffusion-proof, the basic body is sealed at a distal out-let opening (111) and at a proximal actuating opening (113) by respective seals which can be removed and/or severed and are sealed in a materially bonded manner onto a supporting surface surrounding the particular opening. The seals can be sealed, in particular inductively, onto the respective supporting surfaces.

### TECHNICAL FIELD

The present invention relates to a container comprising a hollow basic body in which a plunger is displaceably arranged. Hereinafter, such containers are referred to as “syringe-like” containers.

### PRIOR ART

Syringes and syringe-like containers are known for a multitude of applications in medical and non-medical fields. For example, a normal one-way injection syringe comprises a hollow cylindrical syringe body made of plastic, in which syringe body a plunger is displaceably arranged. Normally the plunger is firmly connected to a plunger rod which extends in proximal direction from the syringe body. Normally, the proximal end of the plunger rod comprises an actuating flange, while normally the syringe body comprises two opposite holding flanges. The syringe is held between the index finger and the middle or ring finger. The thumb exerts pressure on the actuating flange in order to dispense a product located in the syringe through a distal outlet opening. The corresponding counter force is taken up by the holding flanges.

Furthermore, multiple syringes are known that comprise two or more interconnected syringe bodies that are arranged so as to be parallel or concentric, in which syringe bodies two or more identical or different components are accommodated, and from which syringe bodies the components can be dispensed by corresponding plungers being displaced. These components can, for example, be two different components of a pharmaceutical product, which components are to be intermixed only immediately prior to being administered, or two or more components of a bone cement or of a medical or non-medical adhesive, for example a fibrin-based medical adhesive. Many other applications of multiple syringes are known or imaginable. Such multiple syringes are frequently designed to be connected to a mixing device in order to intermix the components to be ejected immediately after they have left the multiple syringe. The plungers are frequently interconnected by way of a common actuating element.

Syringe-like containers are also used in the form of cartridges for special dispensers. In this case the external shape of the container frequently matches the use in a particular dispenser. A dispenser with a cartridge for two components is, for example, disclosed in WO 2008/009143.

In some applications it is desirable or mandatory for the product to be ejected to be stored for an extended period of time directly in a syringe-like container. The product can, for example, be a highly volatile, aggressive, hygroscopic or oxygen-sensitive substance. However, many commercially available plastics, for example the frequently used polyethylene, have a relatively high permeability to light molecules and thus provide an inadequate barrier to the diffusion of contents from the interior of the container to the exterior, or of extraneous substances such as water or volatile substances and gases from the exterior of the container towards the interior. Products stored in a container comprising such a plastic material can thus alter their characteristics in an undesirable manner when stored over an extended period of time.

While it is known per se to improve the diffusion resistance of plastics by suitable coatings, such coatings are usually not transparent. It is therefore not possible to visually check the contents of a coated container, for example in order to exclude the presence of air bubbles.

In order to store sensitive or aggressive products over extended periods of time in a diffusion-proof manner, it is known to hermetically seal such products in glass ampoules. However, it is very cumbersome to remove a product from such a container, because to this effect the ampoule needs to be broken or shattered.

It is also known to accommodate fluid products in so-called carpules made from glass. A carpule is a syringe-like container with a distal dispensing aperture and a proximal actuating opening. The distal dispensing aperture is closed off by a septum closure, i.e. by a penetratable cover, for example made from rubber, which normally is mechanically held on the container by means of a crimped aluminium rim. A displaceable plunger is inserted into the proximal end, which plunger closes off the container proximally. However, diffusion through the seals of the plunger and/or of the septum cannot reliably be excluded in carpules.

### SUMMARY OF THE INVENTION

It is an object of the present invention to provide a syringe-like container that comprises reduced permeability to light molecules, thus providing improved diffusion resistance.

The above-mentioned object is met by a container with the features of claim 1.

The present invention furthermore relates to a dispenser with the features of claim 9 and to a method for manufacturing a container with a product contained therein, wherein the method comprises the features of claim 14.

Further embodiments are provided in the dependent claims.

A container is proposed that comprises a hollow basic body made from mineral glass, the container having a distal outlet opening and a proximal actuating opening, wherein the actuating opening is suitable and intended for inserting an actuating element into the interior of the basic body. In the basic body a plunger is arranged so as to be displaceable along a longitudinal direction in order to dispense from the container a flowable product that is present in the basic body between the plunger and the outlet opening. In order to improve the diffusion resistance of the container, the outlet opening is closed off by means of a first separable and/or removable seal, in particular a pull-off seal, that has been integrally sealed onto a first supporting surface surrounding the outlet opening, while the actuating opening is closed off by means of a second separable and/or removable seal, in particular a pull-off seal, that has been integrally sealed onto a second supporting surface surrounding the actuating opening.

In this manner a container is created which already because of the selection of materials of the basic body per se comprises very low permeability through the container wall. In addition, because of the seals, any diffusion in the region of the outlet opening or through the sealing gap between the plunger and the container wall is also prevented or at least significantly reduced. Consequently, such a container is suitable for longer-term storage of the product contained in the container. When the product is to be dispensed from the container, the seals can be separated or removed in a simple manner, e.g. by being penetrated or by being pulled off.

The product received in the container can be any flowable product, in particular a liquid, a suspension or emulsion, a gel, a paste or some other form of a flowable product with increased viscosity, a powder etc. The product is received in a product receiving region of the container, which product receiving region is preferably directly delimited by the basic body, the plunger and the first seal, i.e. there is no further shell between the product and the basic body, the plunger and the first (distal) seal. In other words the container is directly opened for dispensing a product in that the first seal is separated or removed. However, in particular a further seal, e.g. a septum closure, can be present which additionally seals off the distal outlet opening. Such an additional seal is then preferably arranged within that region of the container that is closed off by the first seal so that the first seal effectively reduces any diffusion which could take place through the additional closure alone.

The first seal and the second seal have been integrally and sealingly applied across the corresponding opening to a supporting surface on the basic body, e.g. adhesively bonded on or welded on (e.g. by laser welding, ultrasound welding or some other known methods). Preferably, the first and/or the second seal have/has been inductively sealed onto the corresponding supporting surface. To this effect the seal comprises at least one electrically-conductive layer and at least one thermoplastic adhesive layer. The seal is pressed onto the corresponding supporting surface and is subjected to an alternating electromagnetic field that induces eddy currents in the conductive layer. As a result of this the seal heats up and consequently the adhesive layer softens. This results in an adhesive connection between the supporting surface and the seal. In the inductive sealing process the use of a basic body comprising mineral glass is particularly advantageous because in contrast to metal-coated plastic containers no eddy currents arise in the basic body, and consequently the product contained in the container heats up only to a small extent.

The corresponding supporting surface preferably extends across, in particular perpendicularly to, the longitudinal direction. In order to increase the area of the supporting surface, the distal end and/or the proximal end can comprise/comprises a supporting flange that extends inwards or outwards across the longitudinal direction, which supporting flange increases the area of the supporting surface of the corresponding seal.

Each seal preferably consists of a relatively thin flat material, wherein the two seals can either consist of the same material or different materials. Preferably, the seals are thin, in particular relative to the surface area covered by the seal, with a thickness of less than 1/10 of the extension perpendicular to the thickness, and preferably thinner than 2 mm or even 1 mm. Preferably the seals are thinner than the sidewall region of the basic body in which the plunger is displaceable.

The seals can, for example, take the form of a single-layer or multi-layer film or foil, or can be formed by a laminate comprising several layers, wherein a layer facing away from the openings can, for example, comprise paper or cardboard. Preferably, each of the seals comprises a carrier, e.g. made of plastic, paper or cardboard, which carrier has at least one barrier layer. The barrier layer can, for example, consist of a diffusion-reducing polymer, e.g. poly(para-xylilene) (Parylene), that has been deposited on the surface of the carrier by a suitable method, e.g. by laminating or by physical or chemical vapour deposition (PVD or CVD). Preferably, however, the barrier layer comprises a metal or a metallic compound, or essentially consists of a metal or a metallic compound. The metal of the barrier layer can, in particular, be selected from the following metals and their alloys: aluminium, titanium, chromium, silver and copper. Aluminium is preferred. The thickness of the barrier layer is preferably approximately 20 nanometres to 20 micrometres. Each of the seals can also entirely consist of metal or of metal and an adhesive layer.

Each of the seals can comprise a weakened region, e.g. a perforation, in order to facilitate separation. As an alternative or in addition, each seal can comprise a tab for pulling the seal off. This tab can be designed so as to protrude from the basic body in order to facilitate gripping the tab.

The basic body is manufactured from a silicate-based mineral glass. Such glasses are frequently referred to as mineral glass in order to differentiate them from glass-like amorphous plastics such as PMMA. The basic body can be coated on the inside and/or on the outside, for example with a layer of lacquer or with a protective layer. Preferably, such a coating of the basic body is transparent in order to allow visual checking of the content of the container.

In some embodiments the basic body can comprise at least one holding flange that is arranged in the region of the actuating opening and that extends across the longitudinal direction, with said holding flange being used to hold in longitudinal direction the container during dispensing. In other words, the container can assume an actual syringe shape. If such a holding flange is present, it is preferred if at its proximal side it is aligned so as to be flush with that region of the basic body that delimits the actuating opening, and if the second seal has been applied to the flange, i.e. if the holding flange at the same time is also used as a proximal supporting flange for the second seal.

The container can receive a single product or several separate products. In particular, the container can comprise at least one second, hollow, basic body, connected to the first basic body, with an interior, with an exterior, with a distal second outlet opening, and with a proximal second actuating opening.

In this case in the interior of the second basic body a second plunger can be displaceably arranged in order to dispense a second product, present in the interior of the second basic body, from the container. In this case a removable or penetratable seal each has then also been sealed onto the second outlet opening and the second actuating opening. In particular, the first outlet opening and the second outlet opening can be jointly closed off by the first seal, and the first actuating opening and the second actuating opening can be jointly sealed off by the second seal.

The container according to the invention can be supplemented by an actuating element to form a dispenser. The actuating element is then designed to interact with the plunger in the interior of the basic body in order to dispense the product from the container. In order to facilitate opening the seal at the actuating opening, the actuating element can comprise at least one separating element that is designed to penetrate the second seal. The separating element can, for example, be a cutting element, a piercing element or a combination of such elements.

In particular, the actuating element can comprise a ram that extends along a longitudinal direction. This ram is then designed at its distal end to cooperate with a proximal rear of the plunger. The separating element can then comprise a blade, arranged in an outer rim region of the distal end, which blade is designed to cut the second seal in a region directly adjoining the basic body. This ensures a clean cut.

Preferably, a complete dispenser furthermore comprises a container holder that receives at least one container of the type stated above at least in part. The container holder then preferably comprises a piercing element for the first seal in order to cut the first seal during insertion of the container in the container holder or during movement in the container holder in the distal direction. In particular, this can be a hollow piercing element that forms a fluid duct in order to guide the product contained in the container to a dispensing aperture of the container holder. To this effect the piercing element can be shaped in the manner of a spike. At the container holder in the region of the dispensing aperture there is preferably a connection structure for connecting an accessory, e.g. a cannula, a mixer or a spray head.

A method according to the invention for manufacturing a container comprises the following steps:
providing a hollow basic body made from mineral glass, the basic body having a distal outlet opening and a proximal actuating opening;
providing a plunger that is displaceable in the interior of the basic body;
filling the interior of the basic body with a flowable product such that the content is delimited by the plunger towards the proximal actuating opening;
integrally applying a first removable and/or separable seal onto a first supporting surface that surrounds the outlet opening; and
integrally applying a second removable and/or separable seal onto a second supporting surface that surrounds the actuating opening, which second supporting surface extends across the longitudinal direction.

Preferably, filling takes place through the outlet opening. As far as further optional details of this method are concerned, reference is made to the details provided above in the context of the device.

### BRIEF DESCRIPTION OF THE DRAWINGS

In the following, preferred embodiments of the invention are described with reference to the drawings, which are only provided for clarification and are not to be interpreted as being limiting. The following is shown in the drawings:

FIG. 1 a perspective partial section view of a dispenser device according to a first, preferred embodiment of the invention;

FIG. 2 a perspective view of a container according to FIG. 1;

FIG. 3 a perspective section view of the container of FIG. 2;

FIG. 4 a exploded view of the dispenser of FIG. 1;

FIG. 5 a central longitudinal section of the dispenser of FIG. 1 without an accessory;

FIG. 6 a central longitudinal section of the dispenser of FIG. 5 after dispensing the contents;

FIG. 7 a central longitudinal section of a dispenser according to a second embodiment of the present invention; and

FIG. 8 a central longitudinal section of a container according to a third embodiment of the present invention.

### DESCRIPTION OF PREFERRED EMBODIMENTS

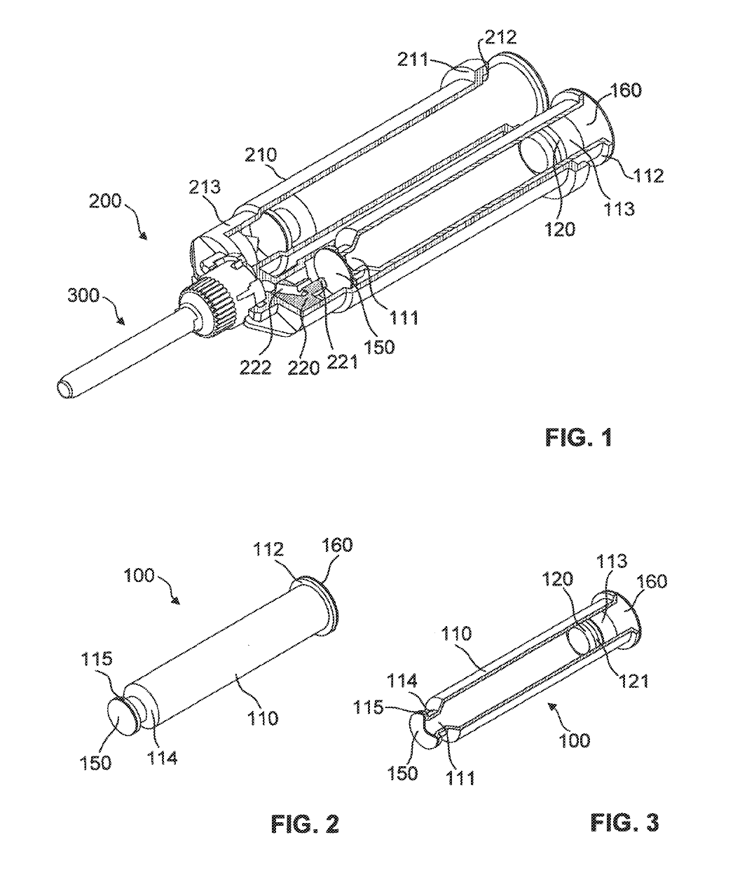

FIGS. 1 to 6 show various views of a dispenser according to a first, preferred embodiment of the present invention. The dispenser comprises a container 100, shown on its own in FIGS. 2 and 3, a container holder 200 and an actuating element 230 that is only shown in FIG. 6.

The container 100 comprises a hollow basic body 110 formed from a mineral glass based on silicate. The basic body comprises a cylindrical sidewall region to which in the region of the distal end of the container a taper 114 adjoins. At the distal end there is a radially-outward projecting first, distal supporting flange 115 that radially surrounds an outlet opening 111. At the proximal end there is an outward-projecting second, proximal supporting flange 112 which radially surrounds a proximal actuating opening 113. In the interior of the cylindrical sidewall region of the basic body 110 a plunger 120, which is displaceable along a longitudinal direction, with a circumferential seal 121 is arranged.

The distal outlet opening 111 is closed off by a first seal 150. To this effect the first supporting flange 115 forms a first supporting surface that extends perpendicularly to the longitudinal direction, onto which the seal 150 has been applied (sealed) in a materially bonded manner. The proximal end of the basic body 110 is also closed off by a second seal 160. To this effect the second supporting flange 112 forms a second supporting surface, which extends perpendicularly to the longitudinal direction, onto which second supporting surface the second seal 160 has been applied in a materially bonded manner.

Both the first seal 150 and the second seal 160 have been applied to the corresponding supporting flange by means of an inductive sealing process. To this effect each of the two seals 150, 160 comprises a multilayer design. A thermoplastic adhesive layer on the surface of the seal faces the corresponding supporting flange. This adhesive layer is followed by a metallic, electrically-conductive barrier layer. In addition, further layers can be present. These further layers can adjoin the metallic barrier layer towards the outside; however, they can also be present between the barrier layer and the adhesive layer. To seal the seal onto the corresponding supporting surface, the seal is pressed onto the supporting surface and is subjected to an alternating electromagnetic field. Consequently, eddy currents develop in the metallic barrier layer, which eddy currents heat up the metallic barrier layer and thus also the further layers of the seal. Because of this heating up, the thermoplastic adhesive layer softens, thus entering an intimate bond with the corresponding supporting surface. In this manner, after the alternating electromagnetic field has been switched off and the seal has been cooled, a liquid-proof and gas-proof connection between the basic body 110 and the corresponding seal 150, 160 is established. Such inductive sealing methods have per se long been known in the state of the art. The adhesive layer can also be formed on the corresponding supporting flange instead of on the seal.

In the application of such an inductive method it is presently particularly advantageous that the basic body 110 consists of a mineral glass. On the one hand mineral glasses are not electrically conductive, and on the other hand they are also relatively poor thermal conductors. Consequently, during inductive sealing only little heat transfer occurs between the corresponding seal 150, 160 and the basic body 110. This prevents the product contained in the container 100 from heating up excessively. If instead the basic body were made from a metallically-coated plastic material, the basic body 110 would also be heated by the alternating electromagnetic field, and consequently heating up the product contained in the container would not be avoidable in this case.

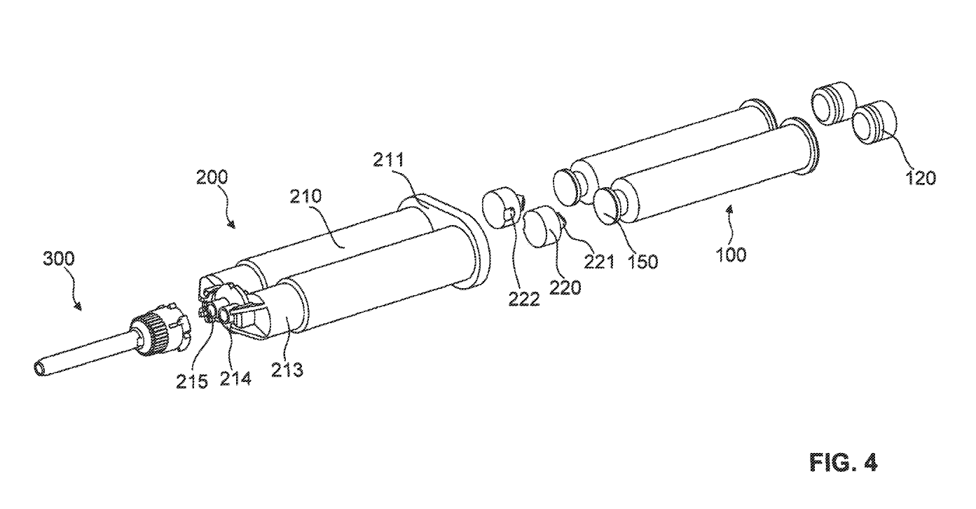

Two containers 100 of the type described above are inserted into the container holder 200. The container holder 200 comprises two parallel, cylindrical receiving regions 210 into which the two containers have been inserted from the proximal side. In a distal outlet region 213 of the container holder 200 in each case an insert 220 has been inserted, on which insert 220 a spike-like piercing element 221 has been formed that points in the proximal direction. The piercing element 221 is hollow; together with the remaining insert it delimits a fluid duct 222 which in each case flows into a dispenser aperture 215 (FIG. 4) of the container holder.

As shown in FIG. 6, the dispenser furthermore comprises an actuating element 230 in the form of a double ram.

The actuating element forms a plunger rod 231 for each of the two plungers 120, which plunger rod 231 comprises at its distal end a feed flange 232 that cooperates with the corresponding plunger 120. At the proximal end the two plunger rods 231 are interconnected by means of a joint actuating flange.

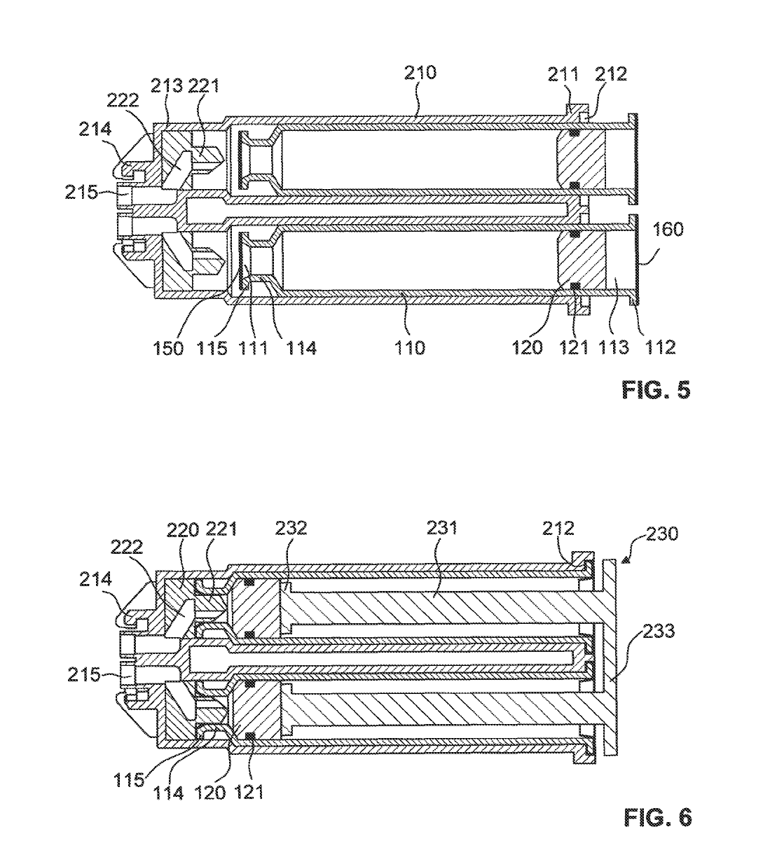

In the position of FIGS. 1 and 5 the corresponding distal ends of the two containers are arranged so as to be spaced apart from the corresponding piercing element 221, and the corresponding first seals 150 are still intact. The container holder can comprise a latching element (not shown) in order to hold the corresponding container in this storage position in a detachable latching connection.

In order to eject the products from the containers 100, the user first displaces the two containers 100 in the distal direction in the container holder 200. If a latching element of the type mentioned above is present, the user exerts increased force for this or disengages the above-mentioned latching connection in some other manner. During the feed motion the piercing elements 221 pierce the corresponding first seal 150, thus establishing a fluid connection between the interior of the corresponding container and the corresponding dispenser aperture 215. When the containers have been slid-in completely, the proximal supporting flange 112 rests against a stop edge 212 of the container holder, which stop edge 212 has been formed by an annular recess in a holding flange 211 of the container holder.

Subsequently, the user removes the two second (proximal) seals 160 and pushes the actuating element 230 from the proximal end into the actuating openings 113 of the two containers 100 in order to advance the two plungers 120 of the containers 100 and in this manner eject the corresponding products contained in the containers 100 through the corresponding outlet opening 111. During this process the corresponding product moves through the corresponding fluid duct 222 to the corresponding dispenser aperture 215. The situation at the end of this dispensing process is shown in FIG. 6.

The distal end of the container holder 200 comprises a connection structure for an accessory 300, in the present case a static mixer. The accessory receives the ejected products from the dispenser aperture 215, mixes them together and delivers the mixture at its own distal end. In the embodiment shown, the connection between the accessory 300 and the container holder 200 is established by way of a bayonet-like device. Such an accessory and its connection with a dispenser device is, in particular, described in detail in document US 2001/0004082, to which express reference is made with respect to the connection of the accessory with the dispenser. The connection between the accessory and the container holder can, however, also be made in some other known manner, for example as a plug-type connection by way of Luer cones.

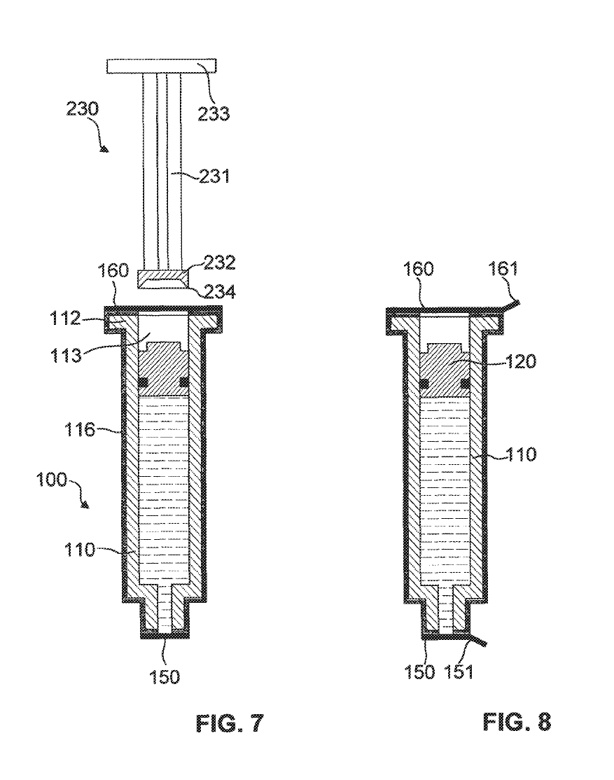

A second embodiment of the present invention is shown in FIG. 7. Components with the same function have the same reference characters as in the first exemplary embodiment. In contrast to that shown in the first exemplary embodiment, the present dispenser does not comprise a separate container holder; instead the user holds the container 100 directly in their hand while sliding-in the actuating element 230. In contrast to the first exemplary embodiment, the present exemplary embodiment comprises only a single container 100, and the actuating element 230 is correspondingly designed only as a single ram. The basic body 110 again consists mineral glass, which in this embodiment, however, is additionally provided with a coating 116 in the form of a lacquer.

In contrast to the first exemplary embodiment, in the present exemplary embodiment the user need not remove the second seal 160 prior to inserting the actuating element 230 into the actuating opening 113; instead the actuating element 230 pierces the second seal 160 during insertion. To this effect the distal end of the actuating element 230 in the region of the feed flange 232 comprises a circumferential circular cutting edge 234 that cuts the seal 160 in a region directly adjacent to the cylindrical sidewall of the basic body 110. Correspondingly, the proximal end of the plunger 120 comprises an annular indentation to receive the cutting edge 234. In this embodiment the first seal 150 can be penetrated by an accessory, or it can be manually removed prior to the content of the container 100 being dispensed.

FIG. 8 shows a third exemplary embodiment in which the first seal 150 comprises a projecting pull-off tab 151 and the second seal 160 comprises a projecting pull-off tab 161. Consequently, in this embodiment the seals can be pulled from the basic body 110 in a particularly easy manner.

Of course, a multitude of modifications are possible without leaving the scope of the invention. In particular, container shapes other than those shown in this document are also possible. The seals 150 and 160 can also have been applied in some manner other than by inductive sealing-on, for example by adhesive bonding or ultrasound welding. Depending on the method of applying the seals, the seals will be of a correspondingly different design, wherein a multilayer structure is preferred. If a container holder is used, it can, of course, also be designed in a manner that differs from that of the above-described first exemplary embodiment, and can, in particular, also comprise other devices for attaching an accessory. Of course, it is also imaginable for such a container holder to receive only a single container, or more than two containers, and for the actuating element to be designed accordingly to advance only a single plunger, or more than two plungers simultaneously. A multitude of other modifications are possible.

### LIST OF REFERENCE CHARACTERS

100 Container
110 Basic body (syringe body)
111 Outlet opening
112 Proximal supporting flange
113 Actuating opening
114 Taper
115 Distal supporting flange
116 Coating
120 Plunger
121 O-ring
150 First seal
151 Tab
160 Second seal
161 Tab
200 Container holder
210 Receiving region
211 Holding flange
212 Stop edge
213 Distal outlet region
214 Connection structure
215 Dispenser aperture
220 Insert
221 Piercing element
222 Fluid duct
230 Actuating element
231 Plunger rod
232 Feed flange
233 Actuating flange
234 Cutting edge
300 Accessory

1. A container, comprising:
a hollow basic body made of mineral glass, with a distal outlet opening and with a proximal actuating opening;
a plunger arranged in the basic body so as to be displaceable along a longitudinal direction in order to dispense from the container a flowable product that is present in the basic body;
a first seal closing off the outlet opening, the first seal being at least one of removable and separable, the first seal being integrally sealed onto a first supporting surface that surrounds the outlet opening; and
a second seal closing off the actuating opening, the second seal being at least one of removable and separable, the second seal being integrally applied onto a second supporting surface that surrounds the actuating opening.

2. The container according to claim 1, wherein at least one of the first seal and the second seal comprises at least one electrically-conductive layer and a thermoplastic adhesive layer and is inductively applied onto the corresponding supporting surface.

3. The container according to claim 1, wherein at least one of the first seal and the second seal has a thickness along the longitudinal direction of less than a tenth of the extension perpendicular to the longitudinal direction.

4. The container according to claim 1, wherein at least one of the first seal and the second seal has a thickness along the longitudinal direction of less than 2 mm.

5. The container according to claim 1, wherein at least one of the first seal and the second seal is designed as a laminate comprising a carrier and at least one diffusion-reducing barrier layer.

6. The container according to claim 5, wherein the barrier layer consists of a metal.

7. The container according to claim 1, wherein at least one of the first seal and the second seal comprises a weakened region to facilitate separation.

8. The container according to claim 1, wherein at least one of the first seal and the second seal comprises a tab for removal of the seal.

9. A dispenser, comprising:
at least one container comprising a hollow basic body made of mineral glass, with a distal outlet opening and with a proximal actuating opening, a plunger arranged in the basic body so as to be displaceable along a longitudinal direction in order to dispense from the container a flowable product that is present in the basic body, a first seal closing off the outlet opening, the first seal being at least one of removable and separable, the first seal being integrally sealed onto a first supporting surface that surrounds the outlet opening, and a second seal closing off the actuating opening, the second seal being at least one of removable and separable, the second seal being integrally applied onto a second supporting surface that surrounds the actuating opening; and
an actuating element which is configured to interact with the plunger in the interior of the basic body of the container in order to dispense a product from the container, wherein the actuating element comprises at least one separating element that is designed to penetrate the second seal.

10. The dispenser according to claim 9, wherein the actuating element comprises a ram that extends along the longitudinal direction, wherein the ram has a distal end that is designed to cooperate with a proximal rear of the plunger, and wherein the separating element comprises a blade, arranged in an outer rim region of the distal end, which blade is configured to cut the second seal in a region directly adjoining the basic body.

11. The dispenser according to claim 9, further comprising:
a container holder that receives the at least one container at least in part, wherein the container holder comprises a piercing element in order to penetrate the first seal.

12. The dispenser according to claim 11,
wherein the container holder comprises a dispensing aperture, and
wherein the piercing element is hollow and forms a fluid duct in order to guide the product contained in the container to the dispensing aperture.

13. The dispenser according to claim 11, wherein the container holder comprises a connection structure for connecting an accessory.

14. A method for manufacturing a container, the method comprising:
providing a hollow basic body made of mineral glass, the basic body having a distal outlet opening and a proximal actuating opening;
providing a plunger that is displaceable in the basic body along a longitudinal direction;
filling the basic body with a flowable product such that the content is delimited by the plunger towards the proximal actuating opening;
integrally applying a first seal that is at least one of removable and separable onto a first supporting surface that surrounds the outlet opening; and
integrally applying a second seal that is at least one of removable and separable onto a second supporting surface that surrounds the actuating opening.

15. The method of claim 14, wherein at least one of the first seal and the second seal comprises at least one electrically-conductive layer and a thermoplastic adhesive layer, and wherein applying at least one of the first and the second seal takes place by inductive sealing.
